(19) United States
(12) Patent Application Publication
(10) Pub. No.: US 2005/0114118 A1
(43) Pub. Date: May 26, 2005

(54) Method and apparatus to reduce latency in an automated speech recognition system

(76) Inventor: Jeff Peck, Los Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/722,038

(22) Filed: Nov. 24, 2003

(51) Int. Cl. G10L 11/06; G10L 15/00; G10L 11/00

(52) U.S. Cl. 704/208; 704/202

(57) ABSTRACT

A method and apparatus to perform automatic speech recognition are described.

### BACKGROUND

A voice over packet (VOP) system may communicate audio information, such as voice information, over a packet network. VOP systems may be particularly sensitive to time delays in communicating the audio information between end points. The time delays may be caused by a variety of factors, such as the delay caused by network traffic, component processing times, application systems, and so forth. One source of the time delay may be a voice activity detector (VAD) for an Automatic Speech Recognition (ASR) system. The VAD may be used to analyze audio information to determine whether it contains voice information. Consequently, reducing time delays in a VOP system in general, and an ASR system in particular, may result in increased user satisfaction in VOP services. Consequently, there may be need for improvements in such techniques in a device or network.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 illustrates a system suitable for practicing one embodiment;

FIG. 2 illustrates a block diagram of a portion of an ASR system in accordance with one embodiment; and

FIG. 3 illustrates a block flow diagram of the programming logic performed by an ASR system in accordance with one embodiment.

### DETAILED DESCRIPTION

Numerous specific details may be set forth herein to provide a thorough understanding of the embodiments of the invention. It will be understood by those skilled in the art, however, that the embodiments of the invention may be practiced without these specific details. In other instances, well-known methods, procedures, components and circuits have not been described in detail so as not to obscure the embodiments of the invention. It can be appreciated that the specific structural and functional details disclosed herein may be representative and do not necessarily limit the scope of the invention.

It is worthy to note that any reference in the specification to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

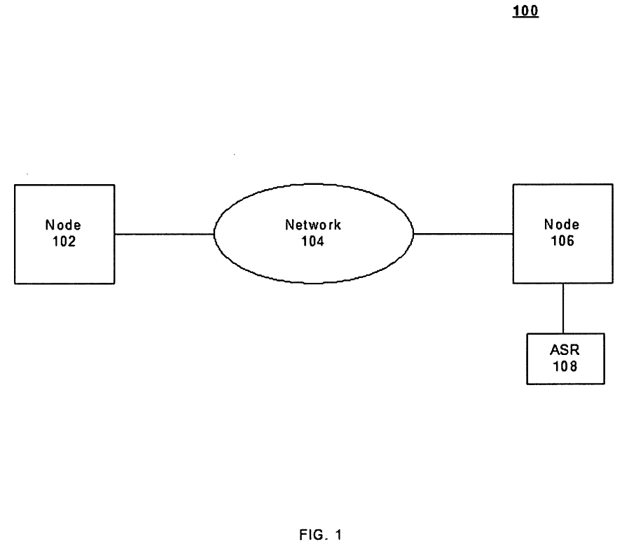

Referring now in detail to the drawings wherein like parts are designated by like reference numerals throughout, there is illustrated in FIG. 1 a system suitable for practicing one embodiment. FIG. 1 is a block diagram of a system 100. In one embodiment, system 100 may be a VOP system. System 100 may comprise a plurality of network nodes. The term “network node” as used herein may refer to any node capable of communicating information in accordance with one or more protocols. Examples of network nodes may include a computer, server, switch, router, bridge, gateway, personal digital assistant, mobile device, call terminal and so forth. The term “protocol” as used herein may refer to a set of instructions to control how the information is communicated over the communications medium.

In one embodiment, system 100 may communicate various types of information between the various network nodes. For example, one type of information may comprise audio information. As used herein the term “audio information” may refer to information communicated during a telephone call, such as voice information, silence information, unvoiced information, transient information, and so forth. As used herein the term “voice information” may comprise any data from a human voice, such as speech or speech utterances. Silence information may comprise data that represents the absence of noise, such as pauses or silence periods between speech or speech utterances. Unvoiced information may comprise data other than voice information or silence information, such as background noise, comfort noise, tones, music and so forth. Transient information may comprise data representing noise caused by the communication channel, such as energy spikes. The transient information may be heard as a “click” or some other extraneous noise to a human listener.

In one embodiment, one or more communications mediums may connect the nodes. The term “communications medium” as used herein may refer to any medium capable of carrying information signals. Examples of communications mediums may include metal leads, semiconductor material, twisted-pair wire, co-axial cable, fiber optic, radio frequencies (RF) and so forth. The terms “connection” or “interconnection,” and variations thereof, in this context may refer to physical connections and/or logical connections.

In one embodiment, the network nodes may communicate information to each other in the form of packets. A packet in this context may refer to a set of information of a limited length, with the length typically represented in terms of bits or bytes. An example of a packet length might be 1000 bytes. The packets may be further reduced to frames. A frame may represent a subset of information from a packet. The length of a frame may vary according to a given application.

In one embodiment, the packets may be communicated in accordance with one or more packet protocols. For example, in one embodiment the packet protocols may include one or more Internet protocols, such as the Transmission Control Protocol (TCP) and Internet Protocol (IP). Further, system 100 may communicate the packet in accordance with one or more VOP protocols, such as the Real Time Transport Protocol (RTP), H.323 protocol, Session Initiation Protocol (SIP), Session Description Protocol (SDP), Megaco protocol, and so forth. The embodiments are not limited in this context.

Referring again to FIG. 1, system 100 may comprise a network node 102 connected to a network node 106 via a network 104. Although FIG. 1 shows a limited number of network nodes, it can be appreciated that any number of network nodes may be used in system 100.

In one embodiment, system 100 may comprise a network nodes 102 and 106. Network nodes 102 and 106 may comprise, for example, call terminals. A call terminal may comprise any device capable of communicating multimedia information, such as a telephone, a packet telephone, a mobile or cellular telephone, a processing system equipped with a modem or Network Interface Card (NIC), and so forth. In one embodiment, the call terminals may have a microphone to receive analog voice signals from a user, and a speaker to reproduce analog voice signals received from another call terminal. Alternatively, one or both of network nodes 102 and 106 may comprise a VOP intermediate device, such as a media gateway, media gateway controller, application server, and so forth. The embodiments are not limited in this context.

In one embodiment, system 100 may comprise an Automated Speech Recognition (ASR) system 108. Although ASR system 108 is shown as a separate module for purposes of clarity, it can be appreciated that ASR system 108 may be implemented elsewhere in system 100, such as part of network 104 or call terminal 106, for example. The embodiments are not limited in this context.

In one embodiment, ASR 108 may be used to detect voice information from a human user. The voice information may be used by an application system to provide application services. The application system may comprise, for example, a Voice Recognition (VR) system, an Interactive Voice Response (IVR) system, a predictive dialing system for call center, speakerphone systems and so forth. The application system may be hosted with ASR 108, or as a separate network node. In the latter case, ASR 108 may be equipped with the appropriate switching interface to switch a telephone call to the network node hosting the appropriate application system.

ASR 108 may also be used as part of various other communication systems other than a VOP system. In one embodiment, for example, cell phone systems may also use ASR 108 to switch signal transmission on and off depending on the presence of voice activity or the direction of speech flows. ASR 108 may also be used in microphones and digital recorders for dictation and transcription, in noise suppression systems, as well as in speech synthesizers, speech-enabled applications, and speech recognition products. ASR 108 may be used to save data storage space and transmission bandwidth by preventing the recording and transmission of undesirable signals or digital bit streams that do not contain voice activity. The embodiments are not limited in this context.

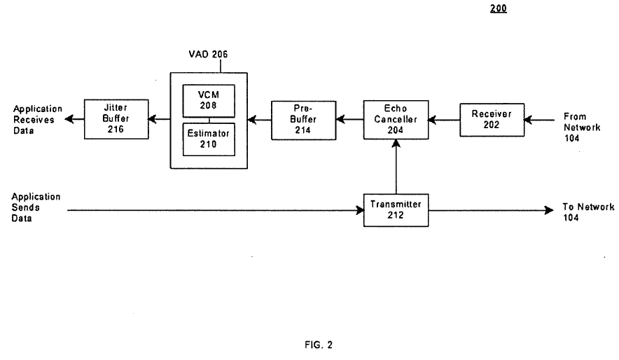

In one embodiment, ASR 108 may comprise a number of components. For example, ASR 108 may include Continuous Speech Processing (CSP) software to provide functionality such as high-performance echo cancellation, voice energy detection, barge-in, voice event signaling, pre-speech buffering, full-duplex operations, and so forth. ASR 108 may be further described with reference to FIG. 2.

In one embodiment, system 100 may comprise a network 104. Network 104 may comprise a packet-switched network, a circuit-switched network or a combination of both. In the latter case, network 104 may comprise the appropriate interfaces to convert information between packets and Pulse Code Modulation (PCM) signals as appropriate.

In one embodiment, network 104 may utilize one or more physical communications mediums as previously described. For example, the communications mediums may comprise RF spectrum for a wireless network, such as a cellular or mobile system. In this case, network 104 may further comprise the devices and interfaces to convert the packet signals carried from a wired communications medium to RF signals. Examples of such devices and interfaces may include omni-directional antennas and wireless RF transceivers. The embodiments are not limited in this context.

In general operation, system 100 may be used to communicate information between call terminals 102 and 106. A caller may use call terminal 102 to call XYZ company via call terminal 106. The call may be received by call terminal 106 and forwarded to ASR 108. Once the call connection is completed, ASR 108 may pass information to an appropriate endpoint, such as an application system, human user or agent. For example, the application system may audibly reproduce a welcome greeting for a telephone directory. ASR 108 may monitor the stream of information from call terminal 102 to determine whether the stream comprises any voice information. The user may respond with a name, such as “Steve Smith.” When the user begins to respond with the name, ASR 108 may detect the voice information, and notify the application system that voice information is being received from the user. The application system may then respond accordingly, such as connecting call terminal 102 to the extension for Steve Smith, for example.

ASR 108 may perform a number of operations in response to the detection of voice information. For example, ASR 108 may be used to implement a “barge-in” function for the application system. Barge-in may refer to the case where the user begins speaking while the application system is providing the prompt. Once ASR 108 detects voice information in the stream of information, it may notify the application system to terminate the prompt, removes echo from the incoming voice information, and forwards the echo-canceled voice information to the application system. The voice information may include the incoming voice information both before and after ASR 108 detects the voice information. The former case may be accomplished using a buffer to store a certain amount of pre-threshold speech, and forwarding the buffered pre-threshold speech to the application system.

ASR systems in general may be sensitive to network latency, which may degrade system performance. The terms “network latency” or “network delay” as used herein may refer to the delay incurred by a packet as it is transported between two end points. An ASR system may introduce extra latency into the system when implementing a number of operations, such as pre-buffering, jitter buffering, voice activity detection, and so forth. Consequently, techniques to reduce network latency may result in improved services for the users of the ASR system. Accordingly, in one embodiment ASR 108 may be configured to reduce network latency, thereby improve system performance and user satisfaction.

FIG. 2 may illustrate an ASR system in accordance with one embodiment. FIG. 2 may illustrate an ASR 200. ASR 200 may be representative of, for example, ASR 108. In one embodiment, ASR 200 may comprise one or more modules or components. For example, in one embodiment ASR 200 may comprise a receiver 202, an echo canceller 204, a VAD 206, and a transmitter 212. VAD 206 may further comprise a Voice Classification Module (VCM) 208 and an estimator 210. Although the embodiment has been described in terms of “modules” to facilitate description, one or more circuits, components, registers, processors, software subroutines, or any combination thereof could be substituted for one, several, or all of the modules.

The embodiments may be implemented using an architecture that may vary in accordance with any number of factors, such as desired computational rate, power levels, heat tolerances, processing cycle budget, input data rates, output data rates, memory resources, data bus speeds and other performance constraints. For example, one embodiment may be implemented using software executed by a processor. The processor may be a general-purpose or dedicated processor, such as a processor made by Intel® Corporation, for example. The software may comprise computer program code segments, programming logic, instructions or data. The software may be stored on a medium accessible by a machine, computer or other processing system. Examples of acceptable mediums may include computer-readable mediums such as read-only memory (ROM), random-access memory (RAM), Programmable ROM (PROM), Erasable PROM (EPROM), magnetic disk, optical disk, and so forth. In one embodiment, the medium may store programming instructions in a compressed and/or encrypted format, as well as instructions that may have to be compiled or installed by an installer before being executed by the processor. In another example, one embodiment may be implemented as dedicated hardware, such as an Application Specific Integrated Circuit (ASIC), Programmable Logic Device (PLD) or Digital Signal Processor (DSP) and accompanying hardware structures. In yet another example, one embodiment may be implemented by any combination of programmed general-purpose computer components and custom hardware components. The embodiments are not limited in this context.

In one embodiment, ASR 200 may comprise a receiver 202 and a transmitter 212. Receiver 202 and transmitter 212 may be used to receive and transmit information between a network and ASR 200, respectively. An example of a network may comprise network 104. If ASR 200 is implemented as part of a wireless network, receiver 202 and transmitter 212 may be configured with the appropriate hardware and software to communicate RF information, such as an omni-directional antenna, for example. Although receiver 202 and transmitter 212 are shown in FIG. 2 as separate components, it may be appreciated that they may both be combined into a transceiver and still fall within the scope of the embodiments.

In one embodiment, ASR 200 may comprise an echo canceller 204. Echo canceller 204 may be a component that is used to eliminate echoes in the incoming signal. In the previous example, the incoming signal may be the speech utterance “Steve Smith.” Because of echo canceller 204, the “Steve Smith” signal has insignificant echo and can be processed more accurately by the speech recognition engine. The echo-canceled voice information may then be forwarded to the application system.

In one embodiment, echo canceller 204 may facilitate implementation of the barge-in functionality for ASR 200. Without echo cancellation, the incoming signal usually contains an echo of the outgoing prompt. Consequently, the application system must ignore all incoming speech until the prompt and its echo terminate. These types of applications typically have an announcement that says, “At the tone, please say the name of the person you wish to reach.” With echo cancellation, however, the caller may interrupt the prompt, and the incoming speech signal can be passed to the application system. Accordingly, echo canceller 204 accepts as inputs the information from receiver 202 and the outgoing signals from transmitter 212. Echo canceller 204 may use the outgoing signals from transmitter 212 as a reference signal to cancel any echoes caused by the outgoing signal if the user begins speaking during the prompt.

In one embodiment, ASR 200 may comprise a pre-buffer 214. Pre-buffer 214 may be used to buffer voice information to assist VAD 206 during the voice detection operation discussed in further detail below. VAD 206 may need a certain amount of time to perform voice detection. During this time interval, some voice information may be lost prior to detecting the voice activity. As a result, a listener may not hear the initial segment of the caller's greeting. This situation may be addressed by storing a certain amount of pre-threshold speech in pre-buffer 214, and forwarding the buffered pre-threshold speech to the appropriate endpoint once voice activity has been detected. The listener may then hear the entire greeting.

In one embodiment, ASR 200 may comprise VAD 206. VAD 206 may monitor the incoming stream of information from receiver 202. VAD 206 examines the incoming stream of information on a frame by frame basis to determine the type of information contained within the frame. For example, VAD 206 may be configured to determine whether a frame contains voice information. Once VAD 206 detects voice information, it may perform various predetermined operations, such as send a VAD event message to the application system when speech is detected, stop play when speech is detected (e.g., barge-in) or allow play to continue, record/stream data to the host application only after energy is detected (e.g., voice-activated record/stream) or constantly record/stream, and so forth. The embodiments are not limited in this context.

In one embodiment, estimator 210 of VAD 206 may measure one or more characteristics of the information signal to form one or more frame values. For example, in one embodiment, estimator 210 may estimate energy levels of various samples taken from a frame of information. The energy levels may be measured using the root mean square voltage levels of the signal, for example. Estimator 210 may send the frames values for analysis by VCM 208.

There are numerous ways to estimate the presence of voice activity in a signal using measurements of the energy and/or other attributes of the signal. Energy level estimation, zero-crossing estimation, and echo canceling may be used to assist in estimating the presence of voice activity in a signal. Tone analysis by a tone detection mechanism may be used to assist in estimating the presence of voice activity by ruling out DTMF tones that create false VAD detections. Signal slope analysis, signal mean variance analysis, correlation coefficient analysis, pure spectral analysis, and other methods may also be used to estimate voice activity. The embodiments are not limited in this context.

In one embodiment, ASR 200 may comprise a jitter buffer 216. Jitter buffer 216 attempts to maintain the temporal pattern for audio information by compensating for random network latency incurred by the packets. The term “temporal pattern” as used herein may refer to the timing pattern of a conventional speech conversation between multiple parties, or one party and an automated system such as ASR 200. Jitter buffer 216 may improve the quality of a telephone call over a packet network. As a result, the end user may experience better packet telephony services at a reduced cost.

In one embodiment, jitter buffer 216 may compensate for packets having varying amounts of network latency as they arrive at receiver 202. A transmitter similar to transmitter 212 typically sends audio information in sequential packets to receiver 202 via network 104. The packets may take different paths through network 104, or may be randomly delayed along the same path due to changing network conditions. As a result, the sequential packets may arrive at receiver 202 at different times and often out of order. This may affect the temporal pattern of the audio information as it is played out to the listener. Jitter buffer 216 attempts to compensate for the effects of network latency by adding a certain amount of delay to each packet prior to sending them to a voice coder/decoder (“codec”). The added delay gives receiver 202 time to place the packets in the proper sequence, and also to smooth out gaps between packets to maintain the original temporal pattern. The amount of delay added to each packet may vary according to a given jitter buffer delay algorithm. The embodiments are not limited in this context.

The relative placement of the VAD with respect to the jitter buffer in the audio information processing operations may affect the overall performance of ASR 200. For example, assume that a jitter buffer is placed before a VAD. In this case, the VAD operations may be delayed by the time needed to fill the jitter buffer. This approach may temporarily “clip” the stream used by the VAD, in which case the agent may not hear the initial segment of the caller's greeting. This situation may be addressed using a pre-buffer, such as pre-buffer 214. The latency incurred by both the pre-buffer and jitter buffer, however, may introduce an intolerable amount of delay in the voice processing operation.

In one embodiment, the operations of VAD 206 are performed before or during the operations of jitter buffer 216. This configuration may solve the above-stated problem, as well as others. As a result, the latency normally consumed while the jitter buffer is being filled can be applied to signal processing operations, such as the operations of VAD 206 and any switching to an appropriate endpoint, e.g., to an application system, call terminal for an agent or other intended recipient of the call. In effect, by the time jitter buffer 216 is filled with the active voice information, VAD 206 may have completed its detection operations. The voice information stored in jitter buffer 216 may then be switched to the appropriate endpoint and immediately rendered to the call recipient, without further latency. By performing VAD on an unbuffered stream of audio information, it may be possible to save 50-100 milliseconds without degrading performance of ASR 200, for example. It is worthy to note that in a VOP system such as VOP system 100, the contents of pre-buffer 214 may be sent to jitter buffer 216 without inducing additional substantive delay. This approach may be difficult to implement, however, for traditional Time Division Multiplexed (TDM) switched telephony systems.

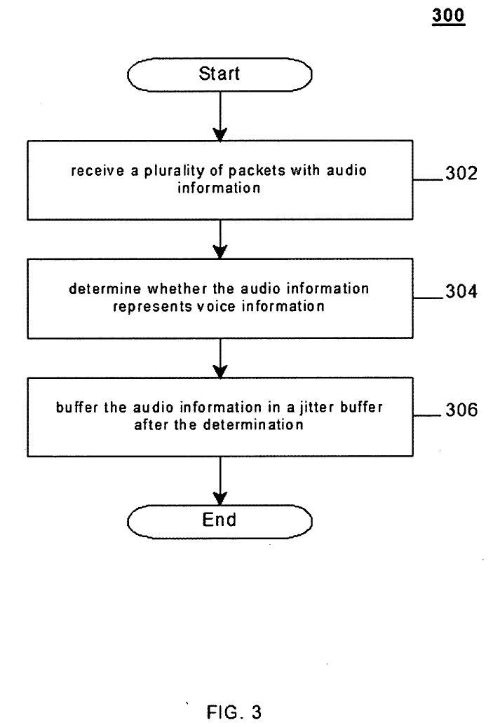

The operations of systems 100 and 200 may be further described with reference to FIG. 3 and accompanying examples. FIG. 3 may represent programming logic in accordance with one embodiment. Although FIG. 3 as presented herein may include a particular programming logic, it can be appreciated that the programming logic merely provides an example of how the general functionality described herein can be implemented. Further, the given programming logic does not necessarily have to be executed in the order presented unless otherwise indicated. In addition, although the given programming logic may be described herein as being implemented in the above-referenced modules, it can be appreciated that the programming logic may be implemented anywhere within the system and still fall within the scope of the embodiments.

FIG. 3 illustrates a programming logic 300 for an ASR system in accordance with one embodiment. An example of the ASR system may comprise ASR 200. As shown in programming logic 300, a plurality of packets with audio information may be received at block 302. A determination may be made as to whether the audio information represents voice information at block 304. The audio information may be buffered in a jitter buffer at block 306 after the determination made at block 304.

In one embodiment, ASR 200 may perform additional operations. For example, ASR 200 may buffer a portion of the received audio information in a pre-buffer for a predetermined time interval prior to the determining operation at block 304. Further, ASR may send the buffered audio information stored in the pre-buffer and the jitter buffer to an endpoint based on the determination at block 304.

In one embodiment, the determination at block 304 may be made by receiving frames of audio information at a VAD, such as VAD 206. VAD 206 may measure at least one characteristic of the frames. The characteristic may be, for example, an estimate of an energy level for the frame. VAD 206 may determine a start of voice information based on the measurements. VAD 206 may determine an end to the voice information based on the measurements and a delay interval.

In one embodiment, the delay interval may represent a time interval after which VAD 206 determines that voice activity has stopped due to some ending condition, such as termination of a telephone call. Since the operations of VAD 206 may occur prior to buffering by jitter buffer 216, a condition may occur where network latency causes packets to arrive outside the temporal pattern of the voice conversation. This condition may sometimes be referred to as “packet under-run.” Consequently, the VAD algorithm implemented by VAD 206 may need to be adjusted to account for packet under-run. Although there are numerous ways to accomplish this, one such adjustment may be to increase the delay time to reduce the potential of artificially detecting an ending condition due to an extended period where packets are not received by receiver 202. This may be accomplished by adjusting the delay interval to correspond to an average packet delay time for the network, such as network 104. The average packet delay time may be predetermined and coded into VAD 206 at start-up. The average packet delay time may also be determined dynamically, and sent to VAD 206 to reflect current network conditions. In the latter case, jitter buffer 216 may measure an average packet delay time, and periodically send the updated average packet delay time to VAD 206.

In one embodiment, echo cancellation may be performed for the received packets prior to voice detection. In this case, for example, a frame of audio information may be retrieved from one or more packets. The frame of audio information may be received by an echo canceller, such as echo canceller 204. Echo canceller 204 may also receive an echo cancellation reference signal. The echo cancellation reference signal may be received from, for example, transmitter 212. Echo canceller 204 may cancel echo from the frame of audio information using the echo cancellation reference signal. The echo canceled frame of audio information may be sent to VAD 206 to perform voice detection.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

1. A method, comprising:
receiving a plurality of packets with audio information;
determining whether said audio information represents voice information; and
buffering said audio information in a jitter buffer after said determination.

2. The method of claim 1, further comprising buffering a portion of said audio information in a pre-buffer for a predetermined time interval prior to said determining.

3. The method of claim 1, further comprising sending said audio information stored in said pre-buffer and said jitter buffer to an endpoint based on said determination.

4. The method of claim 1, wherein said determining comprises:
receiving frames of audio information at a voice activity detector;
measuring at least one characteristic of said frames;
determining a start of voice information based on said measurements; and
determining an end to said voice information based on said measurements and a delay interval.

5. The method of claim 4, wherein said characteristic comprises an estimate of an energy level for said frame.

6. The method of claim 4, further comprising adjusting said delay interval to correspond to an average packet delay time.

7. The method of claim 4, further comprising:
measuring an average packet delay time by said jitter buffer; and
sending said average packet delay time to said voice activity detector.

8. The method of claim 1, wherein said receiving comprises:
retrieving a frame of audio information from said packets;
receiving an echo cancellation reference signal;
canceling echo from said frame of audio information; and
sending said frame of audio information to a voice activity detector.

9. A system, comprising:
an antenna;
a receiver connected to said antenna to receive a frame of information;
a voice activity detector to detect voice information in said frame; and
a jitter buffer to buffer said information after said detection by said voice activity detector.

10. The system of claim 9, further comprising an echo canceller connected to said receiver to cancel echo.

11. The system of claim 10, further comprising a transmitter to provide an echo cancellation reference signal to said echo canceller.

12. The system of claim 9, further comprising a pre-buffer to store pre-threshold speech during said detection by said voice activity detector.

13. The system of claim 9, where said voice activity detector further comprises:
an estimator to estimate energy level values; and
a voice classification module connected to said estimator to classify information for said frame.

14. An article comprising:
a storage medium;
said storage medium including stored instructions that, when executed by a processor, result in receiving a plurality of packets with audio information, determining whether said audio information represents voice information, and buffering said audio information in a jitter buffer after said determination.

15. The article of claim 14, wherein the stored instructions, when executed by a processor, further results in buffering a portion of said audio information in a pre-buffer for a predetermined time interval prior to said determining.

16. The article of claim 14, wherein the stored instructions, when executed by a processor, further results in sending said audio information stored in said pre-buffer and said jitter buffer to an endpoint based on said determination.

17. The article of claim 14, wherein the stored instructions, when executed by a processor, further results in said determining receiving frames of audio information at a voice activity detector, measuring at least one characteristic of said frames, determining a start of voice information based on said measurements, and determining an end to said voice information based on said measurements and a delay interval.

18. The article of claim 17, wherein the stored instructions, when executed by a processor, further results in adjusting said delay interval to correspond to an average packet delay time.

19. The article of claim 17, wherein the stored instructions, when executed by a processor, further results in measuring an average packet delay time by said jitter buffer, and sending said average packet delay time to said voice activity detector.

20. The article of claim 14, wherein the stored instructions, when executed by a processor, further results in said receiving by retrieving a frame of audio information from said packets, receiving an echo cancellation reference signal, canceling echo from said frame of audio information, and sending said frame of audio information to a voice activity detector.
